(19) United States
(12) Patent Application Publication
(10) Pub. No.: US 2002/0139239 A1
(43) Pub. Date: Oct. 3, 2002

(54) Line throwing rescue line

(76) Inventor: Joseph Dwayne Vogl, Dover, DE (US)

Correspondence Address: John C Andrade, 116 W Water Street, P O Box 598, Dover, DE, 19903, US

(21) Appl. No.: 09/569,840

(22) Filed: May 12, 2000

(51) Int. Cl. F41F 5/00; B64D 1/04

(52) U.S. Cl. 89/1.34

(57) ABSTRACT

This invention is a line throwing rescue gun which is inexpensive and easy and efficient to use. The rescue gun utilizes a combustible gas which is sprayed into a chamber of the rescue gun and then igniting thereby propelling a projectile attached to a line over a substantial distance. The invention is also a method for using a rescue gun wherein the projectile is greased and ramrodded into the barrel of the rescue gun, whereby an aerosol combustible gas is sprayed into the chamber of the rescue gun, the chamber is sealed and the gas is ignited thereby propelling the projectile through the barrel towards a specified target.

### FIELD OF THE INVENTION

This invention relates to a line throwing rescue gun, whereby a projectile attached to a string or rope is propelled by means of the ignition of a combustible gas, in a chamber, through an elongated cylindrical barrel. The invention further relates to the simple and efficient construction and use of such gun and the utilization of the ignitable combustible gas as the propellant.

### BACKGROUND

Means for propelling a projectile attached to a line over ground or water have been known in the art.

The Wheelwright, et. al. patent, U.S. Pat. No. 2,876,702 discloses a line throwing apparatus where the line is thrown by means of a rocket.

The Hubener patent, U.S. Pat. No. 3,583,087 discloses a line throwing gun utilizing a conventional shotgun and a special shotgun cartridge for spreading the energy thus reducing the recoil on the gun.

Nelson, et. al., U.S. Pat. No. 4,505,179 discloses a line throwing device adapted to be launched from a tubular launching device such as a riot gun wherein rocket engine means are mounted at the rear end of the projectile for propelling the projectile.

The Perkins patent, U.S. Pat. No. 4,799,906 discloses a rescue apparatus consisting of a launcher, a missile, and a non-lethal firearm adapted to fire a blank round.

The Komblith patent, U.S. Pat. No. 5,398,587 discloses a gas propelled line deployment system, for firing a bullet-shaped projectile. A carbon dioxide gas canister introduces a pressurized gas flow into a launch tube which builds up a propulsion force which propels the projectile outwardly from the launch tube deploying the line.

The Salvemini patent, U.S. Pat. No. 5,690,524 discloses a life line with a life support apparatus which can be launched by a missile which includes a cartridge of pressurized gas that serves as the missile propellant.

### PROBLEMS THE INVENTION SEEKS TO SOLVE

The need exists for an inexpensive and efficient line throwing apparatus that is easy to use and effective in quickly throwing a line during a rescue effort. An object of the present invention is to have a line throwing rescue gun that is inexpensive and affordable by most fire companies and other rescue operations and at the same time is easy to use so that it can be used quickly and efficiently in an emergency situation.

### SUMMARY OF THE INVENTION

The present invention provides a line throwing rescue gun that is relatively inexpensive and very easy to use. The gun itself comprises a barrel having a first and second end and a chamber having a front end and an access port where the front end is rigidly connected to the second barrel end and the access port is suitable for introducing a combustible gas into the chamber. In addition, the gun has an ignition means for igniting the combustible gas which includes an ignition source and ignition igniter. The ignition source is within the chamber and the ignition igniter is outside the chamber. The access port preferably has a removable cap having a threaded exterior and a circular access opening threaded around the interior of the opening. The cap can be screwed and unscrewed to the access port opening. The barrel of the rescue gun is preferably elongated and cylindrical and a site angle finder should be attached to the barrel for determining the angle for firing the line throwing rescue gun. For convenience a strap for carrying the rescue gun is connected to the outside of the barrel and the chamber.

The projectile to be fired by the rescue gun is insertable in the barrel's first end through the barrel to the barrel's second end and forms an airtight seal preventing the combustible gas from exiting the chamber until the gas is ignited by the ignition means. The projectile is cylindrically shaped and has an opening through the center of the projectile suitable for attaching a line through the projectile. The projectile is a hard plastic and has at least one gasket around its exterior to aid in forming an airtight seal.

The rescue gun preferably also includes a second ignition means including an ignition source and an ignition igniter rigidly connected to the cap so that when the cap is screwed into the access port opening, the ignition source is within the chamber and the ignition igniter is outside the chamber. The rescue gun can be used with a line such as a fishing line or it can be used with a rope. The rope should extend through the opening of the center of the projectile and be secured to said projectile typically by a knot that would be bigger than the opening, and the rescue gun preferably includes a means for holding the rope attached to the barrel in such a manner that the rope would not become entangled. This is typically accomplished by wrapping the rope in a FIG. 8 around the means for holding the rope.

The method of using the rescue gun is to grease the projectile attached to the rescue line. The projectile would have an exterior the same shape as the interior of said barrel and that would preferably be cylindrical. The projectile should be ramrodded into the barrel so that the exterior of the projectile forms an airtight seal with the interior of the barrel and chamber. Next, an aerosol combustible gas should be sprayed into said chamber. The aerosol would have to be ignitable and typically a butane containing aerosol would be suitable. In demonstrations where the gun was used, the aerosol utilized was Right Guard* underarm deodorant aerosol. *(Right Guard is a registered trademark of Gillette Company).

After the aerosol is sprayed into the chamber, the chamber needs to be sealed so that it is air tight, the barrel is then aimed towards the target for throwing the rescue line and the aerosol combustible gas is ignited thereby projecting the projectile through the barrel and sending the projectile and rescue line toward the target. The optimum angle for firing the rescue line has been found to be a 45 degree angle. The preferable way of firing the line when a rope is utilized as opposed to a fishing line type of line, is to wrap the rope in a FIG. 8 around a rope holding means attached to the barrel. After the rope is fired if there is not time then the rope should simply be set out on the ground and the projectile loaded and the gun re-fired and if there is time, the line should then be threaded back onto the rope holding means in a FIG. 8.

### BRIEF DESCRIPTION OF THE DRAWINGS

FIG. 1 is a perspective view of the line throwing rescue gun of the present invention with the line being string.

FIG. 2 is a perspective view of the line throwing rescue gun of the present invention wherein the line is rope.

FIG. 3 is a perspective view of the projectile of the present invention.

FIG. 4 is a rear perspective view of the access port of the chamber of the present invention, and the screw on cap for the access port.

FIG. 5 is a prospective view of the line throwing rescue gun of the present invention with a rope holding attachment attached to the gun.

### DESCRIPTION OF THE PREFERRED EMBODIMENT

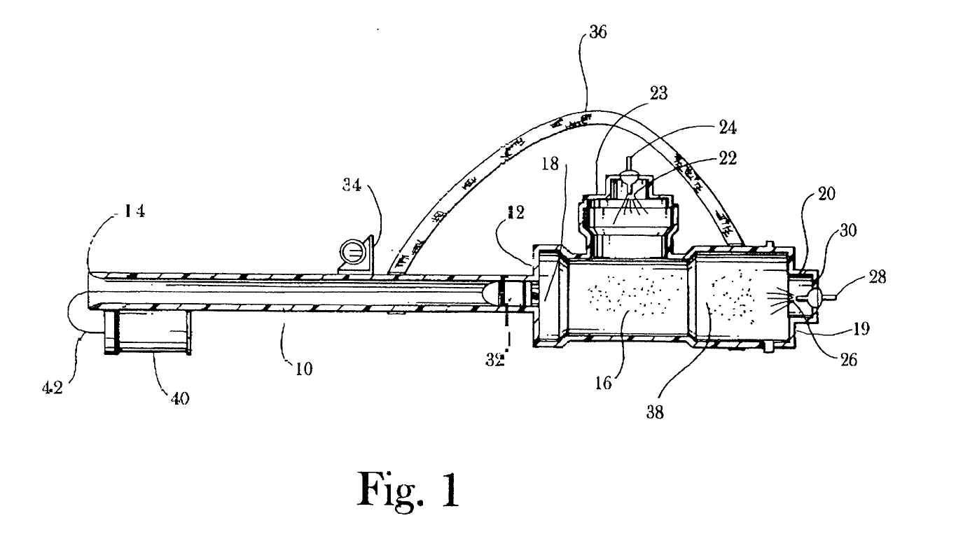

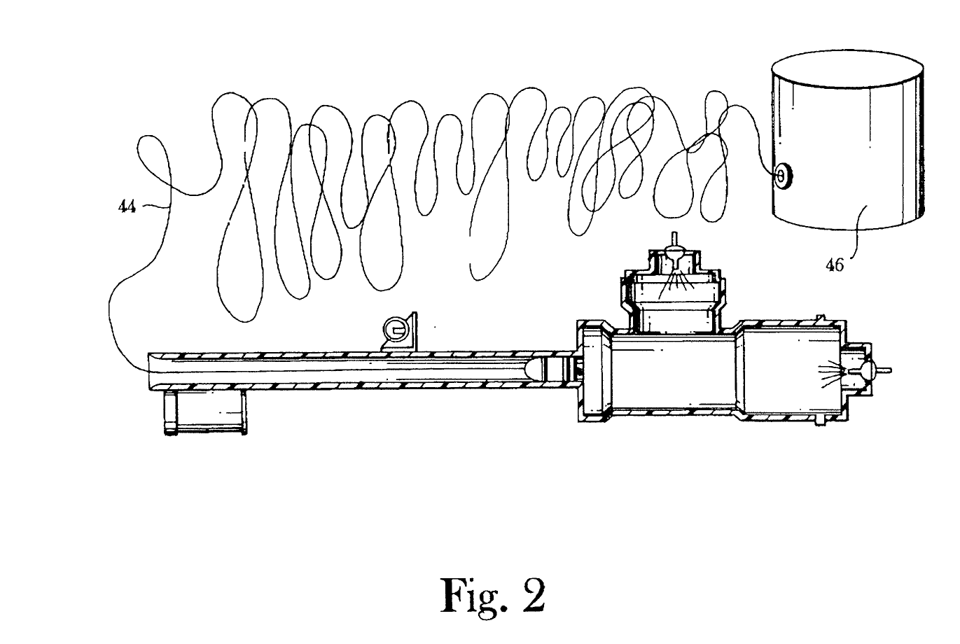

The line utilized by the line throwing rescue gun can be a string or a rope. FIG. 1 shows the line throwing rescue gun utilizing a string and FIG. 2 shows the line throwing rescue gun utilizing a rope.

The barrel 10 is cylindrical and elongated and has a first barrel end 14 where the projectile 32 would exit the barrel 10. The second barrel end 12 is rigidly connected to the chamber 16 through the first chamber end 18. The barrel 10 can be welded to the chamber 16 or the barrel 10 could be molded into the chamber 16.

At the second 19 end of the chamber opposite the first end 18 is the access port 20 and the removable chamber cap 30 which can be screwed and unscrewed into the access port 20. Only one ignition source is necessary to ignite the combustible gas 38 inside the chamber 16. However, in FIG. 1, dual ignition sources are shown, which generally provides for a better ignition. The first ignition source 22 and second ignition source 26 are shown within the chamber and the first ignition igniter 24 and the second ignition igniter 28 are shown on the outside of the chamber. The first ignition source 22 is located within the t-end 23 of the chamber 16 and the first ignition igniter 24 is located on the exterior of the t-end 23 of the chamber 16. The chamber 16 shown in FIG. 1 is a T-Section of a schedule 80 PVC pipe. In addition, the second ignition source 26 is on the inside of the cap 30 and the second ignition igniter 28 is on the outside of the cap 30. An ignition source would be something that would produce a spark or ignition source such as a spark plug.

The most efficient firing angle for propelling the projectile out of the barrel 10 of the rescue gun has been found to typically be 45 degrees. A range finder 34 is provided to aid the operator of the rescue gun to locate the 45 degree angle or depending on the circumstances, whatever angle is optimal under the existing circumstances.

For the convenience of the operator, a strap 36 is provided so that the rescue gun can be strapped around the shoulder of the operator.

A spool of string 40 is located under the barrel and the string 42 is shown attached to the projectile 32 in FIG. 1.

The string is much better than rope when the object is to fire the projectile over the longest distance and tests have shown the projectile can be fired well over 300 feet when attached to the string. When a heavier line is needed, the line can be a heavier rope and while the distance the projectile can be fired will probably decrease to approximately 100-150 feet depending on the conditions, the heavier rope is necessary for many rescue situations.

FIG. 2 is the same as FIG. 1 except that it shows the rope 44 and a can for holding the rope 46. The rope 44 is removed from the can prior to firing the gun and is laid out on the ground. This is necessary for the rope, because unlike with the string, the unraveling of the rope during firing would produce substantially greater friction and resistance, substantially decreasing the distance the rope could be fired.

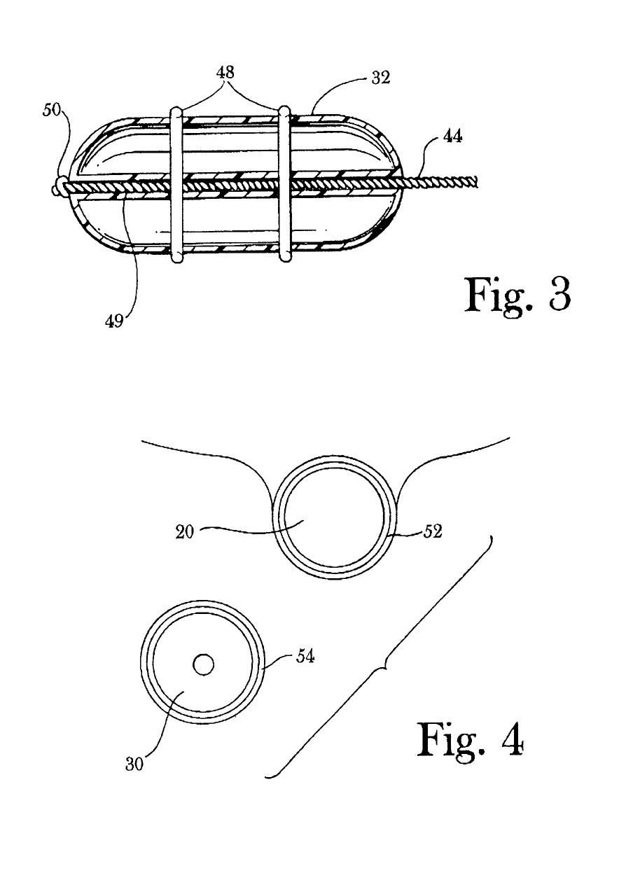

FIG. 3 shows the projectile 32 of the present invention as cylindrically shaped with a hollow opening 49 in the center of the projectile. To aid in the airtight seal, O ring gaskets 48 are utilized around the projectile and they are fitted around grooves (not shown) in said projectile The projectile 32 shown in FIG. 3 is shown with a rope 44 which passes through the opening 49 in the center of the projectile 32 and is tied in a knot 50 at the end of the projectile 32.

FIG. 4 shows the access port 20 of the present invention with a threaded interior 52 and the removable cap 30 with a threaded exterior 54. The threading of the cap so that it can be screwed and unscrewed is the preferable way of attaching the cap to seal the access port but other means for closing said access port so that it can be opened to insert the combustible gas and closed when the gas is ignited would also be available.

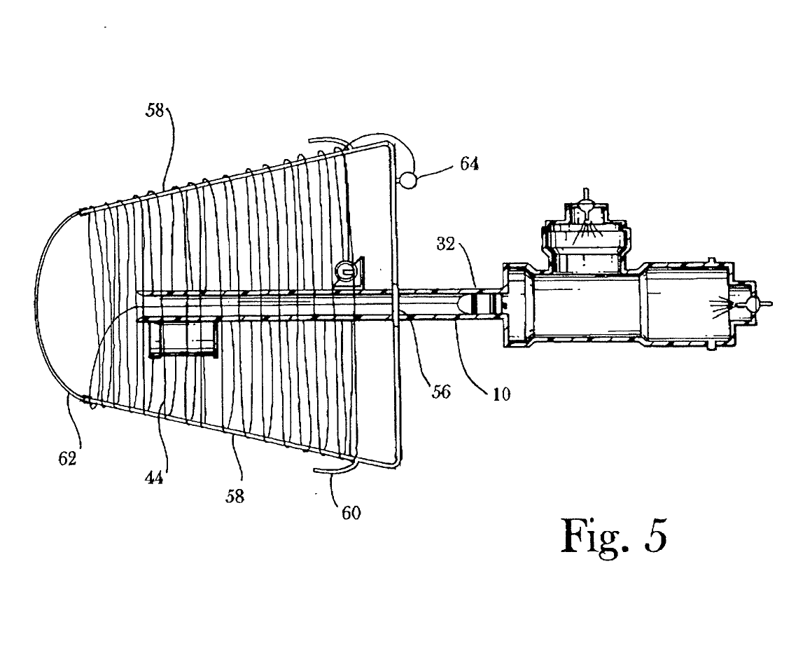

FIG. 5 shows the line throwing gun of the present invention with an attachment for holding rope 44 while the gun is in use. The rope holder is in the shape of a squared U narrowing at the top of the U as shown in FIG. 5. The rope holder is a rod 58 preferably steel and can be one continuous rod or two or more rods welded together. For convenience, a guide 60 is attached on both sides as shown in FIG. 5 and is for the purpose of helping to hold the rope 44. The rods are clamped to the barrel 10 and can be clamped on in such a way as to either be permanently attached or removable. To attach the rope, the rope is tied to a tie down or anchor 64 which the rope 44 is tied securely to. The rope is then wound in a FIG. 8 shape and the end of the rope 44 is attached to the projectile 32 and loaded into the barrel. This preferred embodiment shown in FIG. 5 has the advantages over the embodiment shown in FIG.2 in that the rope is launched from a slightly higher elevation and the rope is an attachment to the gun itself rather than the add on pail 46 shown in FIG. 2. A rubber tube 62 is attached at the end of the rods 58 in order to help keep the rope in place while the gun is being transported but is removed prior to the time the projectile 32 is fired.

After the rope is fired, if the gun needs to be re-used, the rope can be simply pulled back, laid on the ground, and re-fired or if there is time, the rope can be re-attached to the rods 58 in a FIG. 8 and re-fired as shown in FIG. 5.

I claim:

1. A line throwing rescue gun comprising:
a) a barrel having a first and second end;
b) a chamber having a front end and an access port, said front end rigidly connected to said second barrel end, said access port suitable for introducing a combustible gas into said chamber; and
c) an ignition means for igniting said combustible gas.

2. The line throwing rescue gun of claim 1 wherein said barrel is cylindrical and elongated.

3. The line throwing rescue gun of claim 1 wherein the ignition means includes an ignition source and an ignition igniter, said ignition source being within said chamber and said ignition igniter being outside said chamber.

4. The line throwing rescue gun of claim 1 wherein said access port comprises a removable cap having a threaded exterior and a circular access opening threaded around the interior of said opening, whereby said cap can be screwed and unscrewed into said access port opening.

5. The line throwing rescue gun of claim 1 further comprising a site angle finder connected to said barrel and suitable for determining the angle for firing the line throwing rescue gun.

6. The line throwing rescue gun of claim 1 further comprising a strap for carrying said rescue gun wherein the strap is connected to the outside of said barrel and said chamber.

7. The line throwing rescue gun of claim 1 further comprising a projectile, said projectile insertable in said barrel first end through said barrel to said barrel second end and forming an airtight seal preventing said combustible gas from exiting said chamber until said gas is ignited by said ignition means.

8. The line throwing rescue gun of claim 7 wherein said projectile is cylindrically shaped having an opening through the center of said projectile suitable for attaching a line through said projectile.

9. The line throwing rescue gun of claim 8 wherein said projectile is comprised of hard plastic and has at least one gasket around its exterior to aid in forming an airtight seal.

10. The line throwing rescue gun of claim 4 further comprising a second ignition means including an ignition source and an ignition igniter rigidly connected to said cap such that when the cap is screwed into said access port opening, said ignition source is within said chamber and said ignition igniter is outside said chamber.

11. The line throwing rescue gun of claim 8, further comprising a rope extending through the opening in the center of said projectile and secured to said projectile.

12. The line throwing rescue gun of claim 8 further comprising a string extending through the opening in the center of said projectile adjacent to said projectile and further comprising a string spool connected on the outside of said barrel.

13. A method of using a line throwing rescue gun having a barrel and a chamber rigidly connected to said barrel to throw a rescue line over a distance comprising:
a) greasing a projectile, attached to a rescue line, having an exterior the same shape and essentially the same size as the interior of said barrel;
b) ramrodding said projectile into said barrel such so that the exterior of said projectile forms an airtight seal with the interior of said barrel and said chamber;
c) spraying an aerosol combustible gas into said chamber;
d) sealing said chamber so it is airtight;
e) aiming said barrel towards a target for throwing said rescue line, and
f) igniting said aerosol combustible gas thereby projecting said projectile through said barrel and sending said projectile and rescue line towards said target.

14. The method of claim 13 wherein said line is a rope and further comprising unraveling said rope before firing said projectile towards said target.

15. Method of claim 13, further comprising a range finder and setting said range finder for firing said line throwing rescue gun at a 45 degree angle.
